(19) United States
(12) Patent Application Publication
(10) Pub. No.: US 2003/0035135 A1
(43) Pub. Date: Feb. 20, 2003

(54) Methods, apparatus, and articles of manufacture for creating three-dimensional and animated images with lenticular and anaglyph viewing devices

(76) Inventor: Richard C. Corrales, Los Angeles, CA (US)

Correspondence Address: EIIC K SATERMO, P O BOX 19099, IRVINE, CA, 92623

(21) Appl. No.: 09/931,796

(22) Filed: Aug. 16, 2001

(51) Int. Cl. B41J 1/00; G06F 15/00

(52) U.S. Cl. 358/1.15; 358/1.9

(57) ABSTRACT

A system for producing a three-dimensional or an animated device includes a computer system and a lenticular assembly. The computer system may include a printer, a monitor, and a computer. Under operation by a user and enablement by accompanying computer code or software, the computer displays a preview window and a plurality of thumbnail windows on the monitor. The user then causes the computer to import an image to each of the thumbnail windows, for example, by dragging and dropping an image file with a mouse. The computer then generates a processed image based on the plurality of images in the thumbnail windows. At this time, the user may modify and adjust the images as desired. When the images are satisfactory, the user may then cause the computer to export the processed image to the printer to generate a print of the processed image. The lenticular assembly includes a lenticular sheet with an adhesive layer to which the user may then mount the print, thereby forming an animated or three-dimensional device.

### BACKGROUND OF THE INVENTION

1. Field of the Invention

The present invention relates to three-dimensional and animated images and, more particularly, to systems and methodology for creating such images on a home or office computer without the need of professional imaging services.

2. Description of Related Technology

An anaglyph image is a moving or still picture consisting of two slightly different perspectives of the same subject in contrasting colors that are superimposed on each other, producing a three-dimensional (3D) effect when viewed through two correspondingly colored filters, typically a red and a blue lens of 3D glasses. In other words, anaglyph imaging refers to those moving or still images that need to be viewed with 3D glasses to produce the 3D effect.

An animated image is a series of successive still images superimposed on each other that when view through a special lens (i.e., a lenticular sheet) and rotated about an axis, produce an animated sequence of the images. A 3D image may also be created by using a lenticular sheet, as opposed to 3D glasses.

Conventionally, such specialized imaging techniques required professional imaging services. Accordingly, the cost of producing a unique or customized animated or 3D device is prohibitive to an individual user. In addition, “fine tuning” of the desired image is out of the user's hands, having to depend upon the judgement of the outside professional service.

In view of the foregoing, there is a need in the art for systems and methodology that enable a user to create his or her own animated or 3D image by using only a desktop computer and conventional printer.

### SUMMARY OF THE INVENTION

The present invention provides a system for producing a three-dimensional or an animated device includes a computer system and a lenticular assembly. The computer system may include a printer, a monitor, and a computer. Under operation by a user and enablement by accompanying computer code or software, the computer displays a preview window and a plurality of thumbnail windows on the monitor. The user then causes the computer to import an image to each of the thumbnail windows, for example, by dragging and dropping an image file with a mouse. The computer then generates a processed image based on the plurality of images in the thumbnail windows. At this time, the user may modify and adjust the images as desired. When the images are satisfactory, the user may then cause the computer to export the processed image to the printer to generate a print of the processed image. The lenticular assembly includes a lenticular sheet with an adhesive layer to which the user may then mount the print, thereby forming an animated or three-dimensional device.

One of the benefits of the present invention is that a user is able to create animated or three-dimensional devices without the need of professional imaging services, thereby saving the user time and expense while enable the user to modify and amend the images and devices as desired.

One of the features of the invention is that the user may select a creation mode, that is, animated, three-dimensional (3D), or anaglyph mode. This selection then causes the computer to display a corresponding mode window on the monitor in which the user may proceed with importing images.

According to another feature of the present invention, the adhesive layer of the lenticular assembly may include pressure-sensitive adhesive. Accordingly, a print may be repositioned on the lenticular sheet or replaced by another print if desired. To aid the user in mounting the print to the lenticular sheet, an alignment mark may be printed on the print for use in aligning the print with lenses of the lenticular sheet.

Additional aspects, features, and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 is a perspective view of an exemplary computer system for creating three-dimensional (3D) and animated prints in accordance with the principles of the present invention;

FIG. 2 is a view of a computer window environment configured according to a preferred embodiment of the invention;

FIG. 3 is a flow chart of exemplary methodology for a user to follow to create 3D and animated prints and images of the invention;

FIG. 4 is a schematic view of a creation-mode window according to a preferred embodiment of the invention, particularly illustrating a 2-flip animation mode window;

FIG. 5 is a schematic view of a creation-mode window according to a preferred embodiment of the invention, particularly illustrating a 3-flip animation mode window;

FIG. 6 is a schematic view of a creation-mode window according to a preferred embodiment of the invention, particularly illustrating a 3D mode window;

FIG. 7 is a schematic view of a creation-mode window according to a preferred embodiment of the invention, particularly illustrating an anaglyph mode window;

FIG. 8 is a flow chart of exemplary methodology for creating animated prints in accordance with the present invention;

FIG. 9 is a view of an interlaced image created according to the invention;

FIG. 10 is a flow chart of exemplary methodology for creating an anaglyph print in accordance with the invention;

FIG. 11 is a plan view of a lenticular assembly configured in accordance with the invention;

FIG. 12 is a cross-sectional view of the lenticular assembly of the invention;

FIG. 13 is a perspective view of a print being mounted to a lenticular sheet in accordance with the invention;

FIG. 14 is a cross-sectional view of a 3D or animated printed mounted to a lenticular sheet according to a preferred embodiment of the invention;

FIG. 15 is a plan view of a lenticular sheet with an adhesive strip according to a preferred embodiment of the invention;

FIG. 16 is a perspective view of a frame including an animated device according to the present invention;

FIG. 17 is a perspective view of stereo viewing glasses for viewing anaglyph prints of the invention; and

FIG. 18 is a plan view of a calibration sheet for calibrating lenticular sheets of the invention.

### DETAILED DESCRIPTION OF THE INVENTION

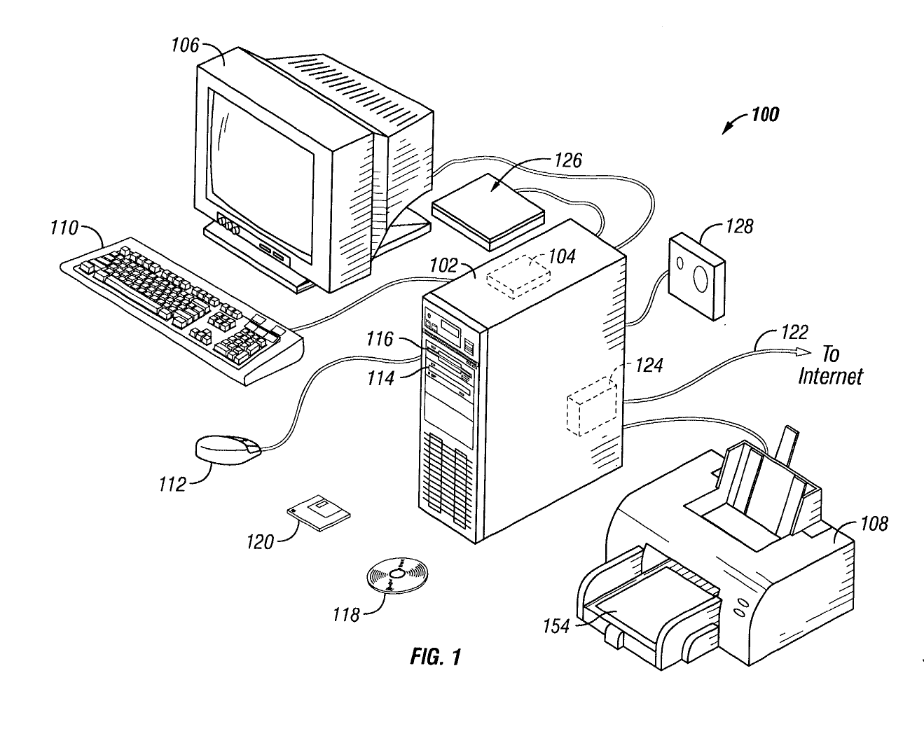

Referring more particularly to the drawings, an exemplary embodiment of a computer system for creating three-dimensional (3D) and animated images in accordance with the principles of the present invention is illustrated in FIG. 1 and indicated with reference numeral 100. A user may utilize exemplary computer system 100 to create his or her own 3D and animated prints economically at home or office and without the need of professional image services.

Exemplary system 100 includes a computer 102 with a processor 104, a monitor 106, and a home or office printing machine such as a printer 108. Interface devices such as a keyboard 110 and a mouse 112 allow a user to interact with the system. Instructions in the form of computer code may be downloaded into computer 102 via a compact disc read-only memory (CD-ROM) drive 114 or a floppy drive 116 for respectively receiving a complementary computer-readable storage medium such as a CD-ROM 118 or a floppy disc 120. Alternatively, computer code may be downloaded into computer 102 through an Internet connection 122 as known in the art. In addition, computer 102 may include a hard disc 124 on which computer code may be stored or “bundled.” Peripherals such as a scanner 126 and a digital camera 128 may also be connected to the system. The plurality of computer-readable instructions cause the processor 104 to operate the system 100 in accordance with the methodology of the invention, which is discussed in detail below.

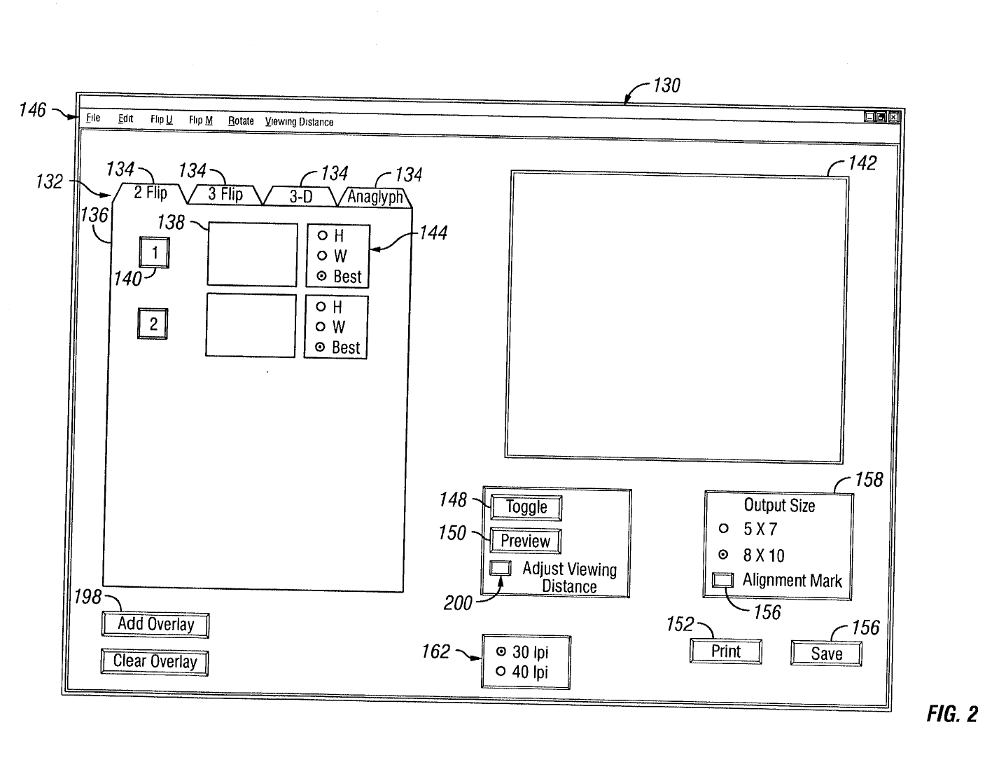

With additional reference to FIG. 2, in accordance with an exemplary embodiment of the invention, a working screen 130 is displayed on the monitor 106. The screen 130 includes a plurality of windows with which a user may create an animated or a 3D image. More particularly, a selection window 132 provides a number of creation-mode selections from which a user may chose. In the preferred embodiment shown, for example, tabs 134 are provided for a 2-flip animated mode, a 3-flip animated mode, a 3D mode, and an anaglyph mode.

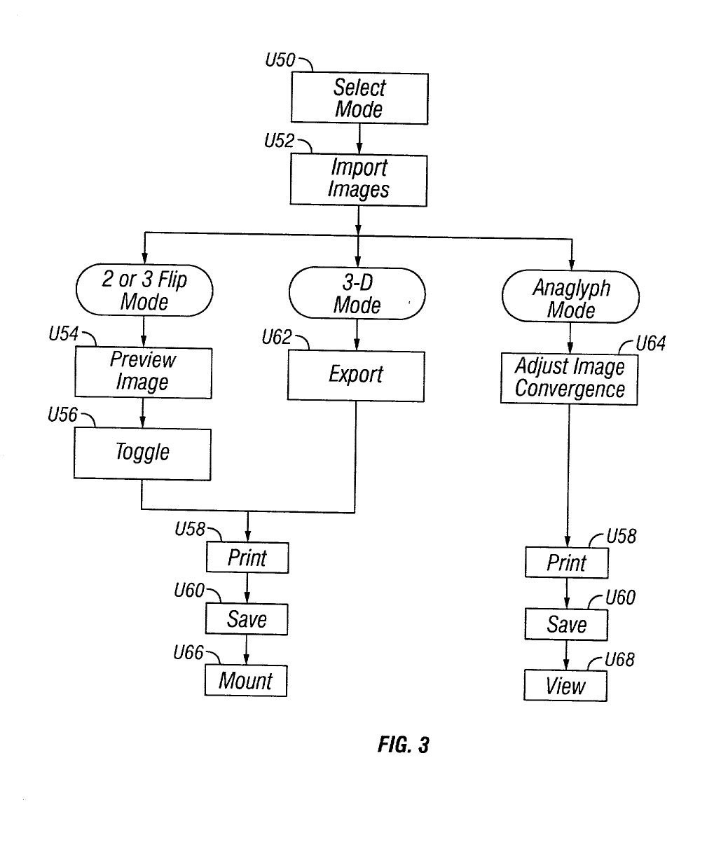

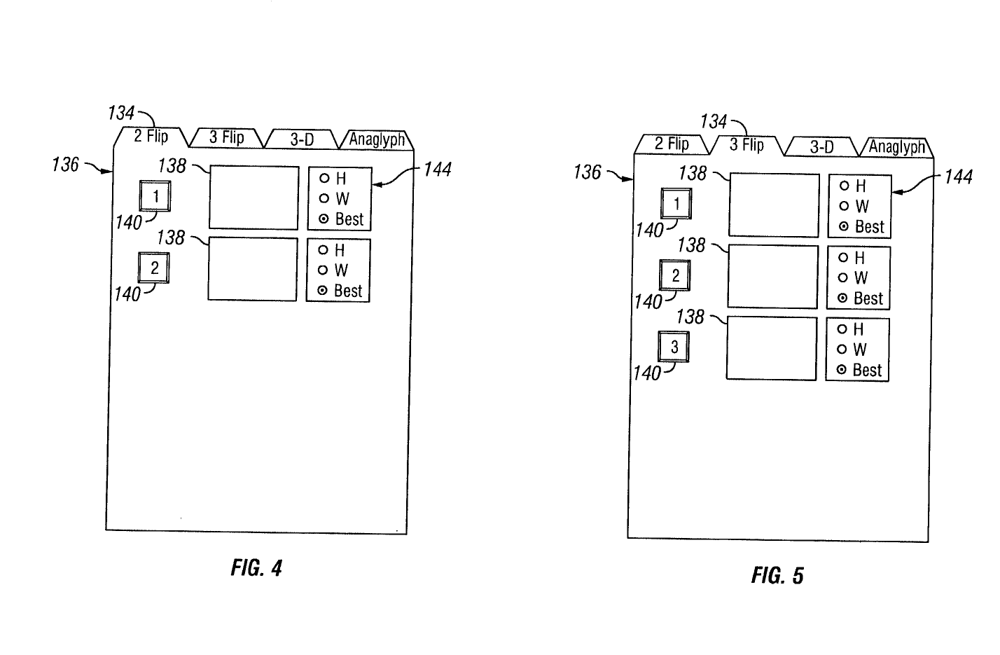

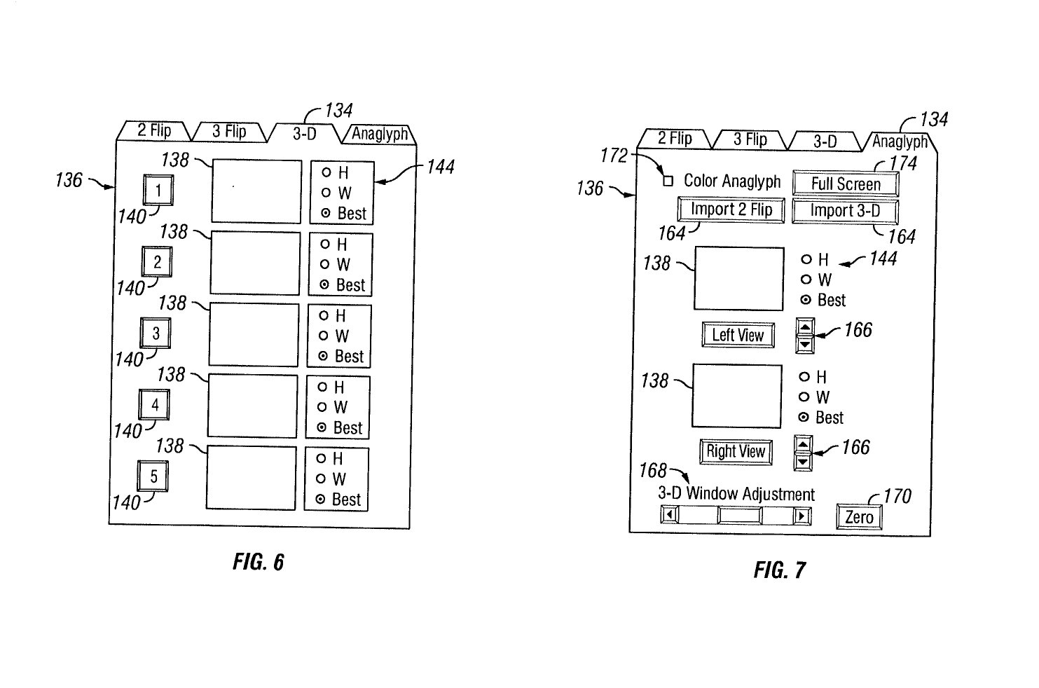

With additional reference to FIG. 3, when a user selects one of the creation modes (step U50) by, e.g., clicking on one of the tabs 134 with the mouse 112, a tab-specific mode window 136 is activated. More specifically, if the 2-flip tab 134 is selected, then a 2-flip mode window 136 as shown in FIG. 4 is displayed; if the 3-flip tab 134 is selected, then a 3-flip mode window 136 as shown in FIG. 5 is displayed; if the 3D tab 134 is selected, then a 3D mode window 136 as shown in FIG. 6 is displayed; and if the anaglyph tab 134 is selected, then a n anaglyph mode window 136 as shown in FIG. 7 is displayed.

Once the creation mode is selected, then a user may import images (step U52) to thumbnail windows 138 within the mode window 136. For example, a user may activate a file-location browser window as known in the art (not shown) by clicking on an import button 140. The user may then drag and drop an image from a file location on the hard drive 124 of the computer 102. Alternatively, image files may be downloaded or imported from a remote source such as the Internet 122, the scanner 126, the digital camera 128, or one of the drives 114 or 116.

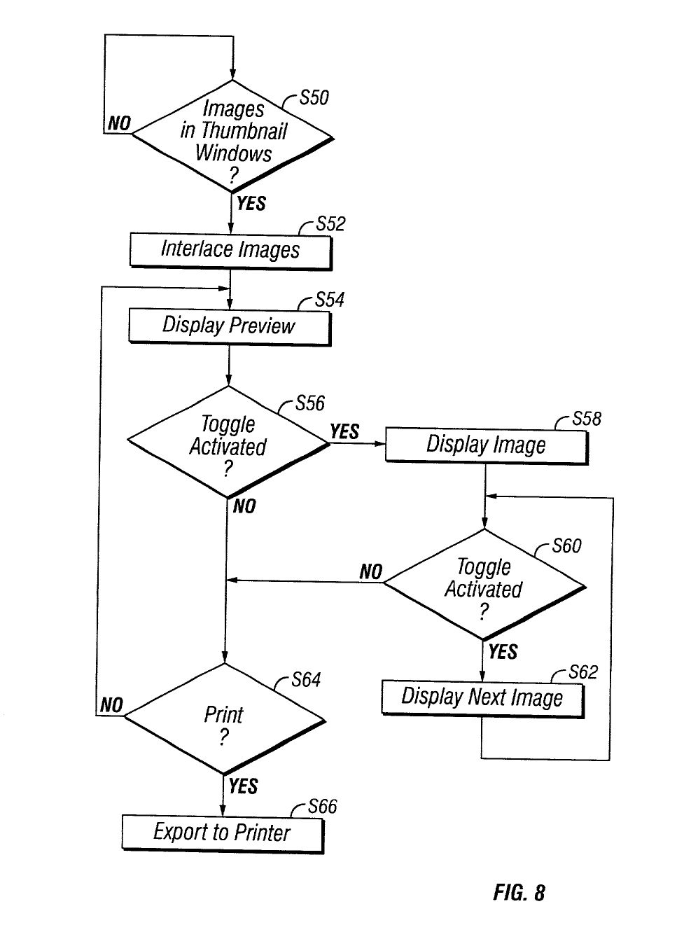

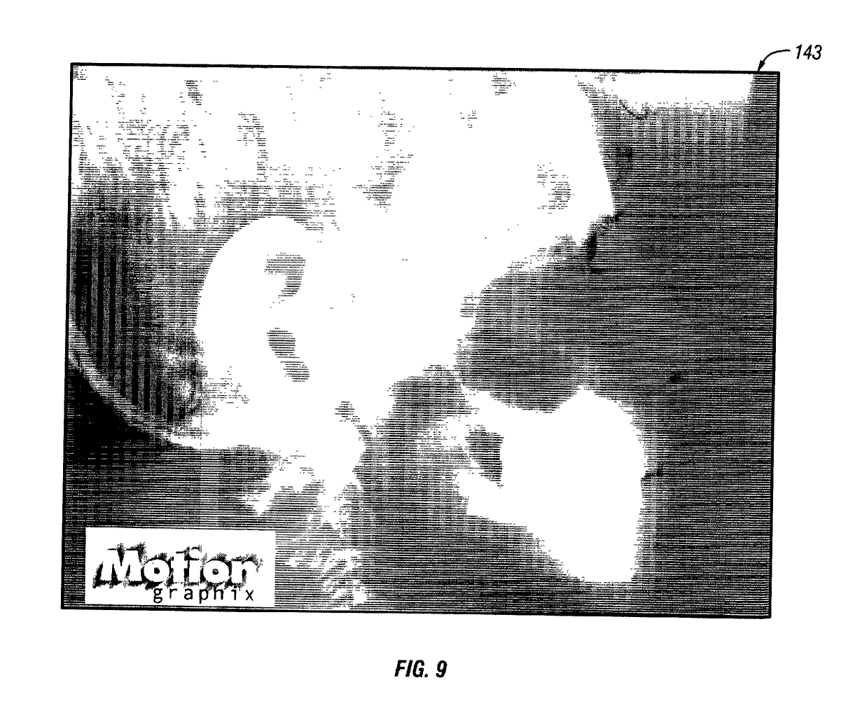

With additional reference to FIG. 8, when an image has been imported into each of the thumbnail windows 138 (step S50), then the code causes the computer 102 to interlace the images (step S52) and to display a preview (step S54) of an interlaced image in a preview window 142 of the screen 130. As known in the art, an interlaced image 143 is created by deleting horizontal rows of pixels from the images at regular intervals, and then superimposing the images together as shown in FIG. 9. Accordingly, for 2-flip animation, one-half of the interlaced image is from a first image, while the other half is from the second image. In general, the interlaced image is a processed image based on the imaged imported to the thumbnail windows 138.

Upon previewing the interlaced image (step U54), the user may modify one or more of the images in the thumbnail windows 138 or adjust how the image fits in each thumbnail window 138 by utilizing radio buttons 144. For example, a computer-determined best fit may be selected, or height or width adjustments may be selected. The image may also be flipped or rotated using appropriate menus on a menu bar 146 of the screen 130.

If 2- or 3-flip mode is selected, a user may toggle (step U56) between the images for viewing in the preview window 142 by clicking a toggle button 148. If clicked (step S56), a first image is displayed (step S58) in the preview window 142. If clicked again (step S60), a subsequent image is displayed (step S62). A preview button 150 may be clicked to view the interlaced image again.

The user may then print (step U58) the interlaced image when satisfied by the preview. A print button 152 may be provided which, when activated (step S64), causes the computer 162 to export (step S64) the interlaced image to the printer 108, thereby providing a print 154. The interlaced image may also be saved (step U60), for which a save button 156 may be provided. A user may selected a desired print size with radio buttons 158, for example, 8 inches by 10 inches or 5 inches by 7 inches. An alignment mark button 160 may be activated so that an alignment mark is printed on the print 154, which is discussed below.

If 3D mode is selected, then up to five images may be imported into the thumbnail windows 138 of the mode window 136 as shown in FIG. 6. For a proper 3D print, the imported images are preferably separated by about 5 degrees of rotation, as appreciated by those skilled in the art. For proper 3D prints, a resolution of 40 lines per inch (lpi) should be selected at resolution radio buttons 162, while 30 lpi should be selected for proper flip animation. The user may export (step U62) to the anaglyph mode for preview and modification if desired.

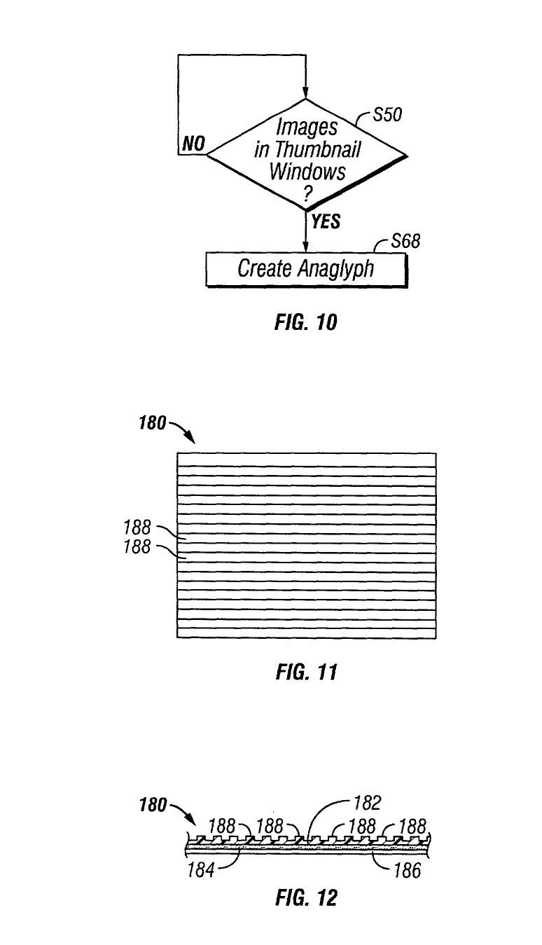

If anaglyph mode is selected, import buttons 164 may be utilized to import images from the 2-flip mode or the 3D mode. Referencing FIG. 10, when the images are in the thumbnail windows 138 (step S50), then the computer 102 creates an anaglyph (step S68) including a right view and a left view each of a corresponding color (i.e., red and blue). A user may adjust an image convergence (step U64) of the anaglyph. This may be done by adjusting the vertical positioning of each view with adjustment buttons 166 and/or the horizontal position of the anaglyph within the preview window with an window adjustment scroll bar 168. A zero button 170 may be provided to center the image horizontally. In addition, a color anaglyph button 172 may be selected to create a color anaglyph if desired by a user, as opposed to a black-and-white anaglyph, and a full-screen button 172 may be provided so that the preview may be viewed full screen on the monitor 106.

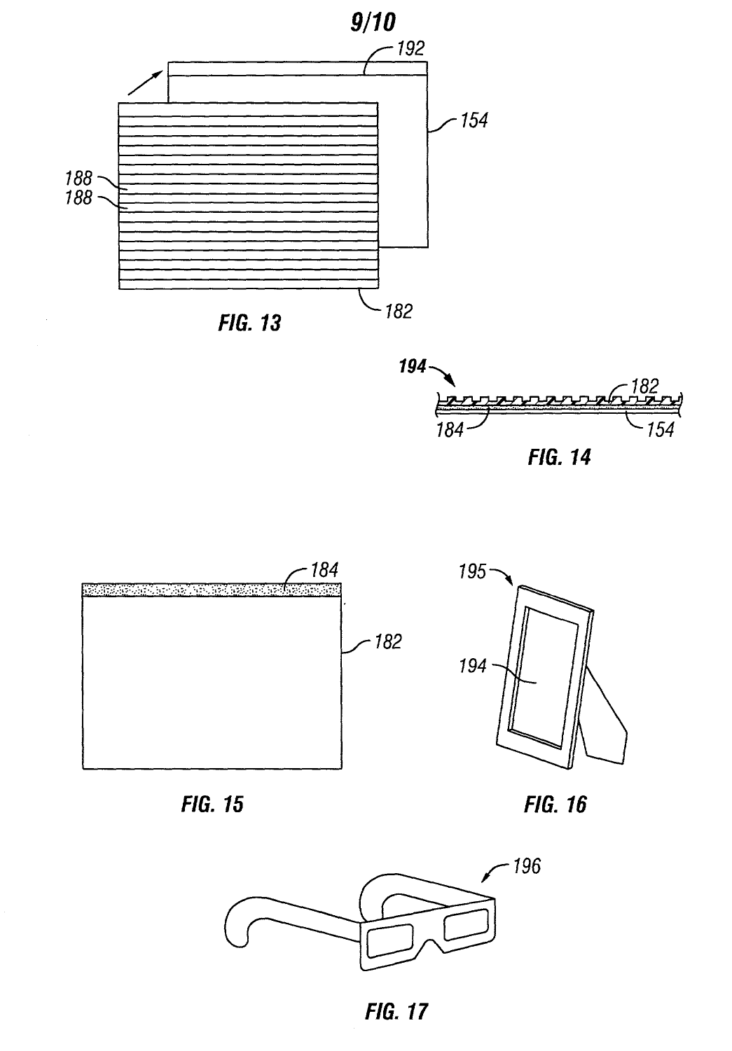

If 2-flip, 3-flip, or 3D mode is selected, the resultant print 154 may then be mounted (step U66) for proper viewing by utilizing a lenticular assembly 180 as illustrated in FIGS. 11 and 12. Exemplary lenticular assembly 180 includes a lenticular sheet 182 with an adhesive layer 184 and a removable backing sheet 186. A user may peel away the backing sheet 186 to expose the adhesive layer 184. The print 154 may then be mounted to the lenticular sheet 182 by positioning the print 154 against the adhesive layer 184, thereby adhering the print to the adhesive. As mentioned above and as shown in FIG. 13, an alignment mark 192 may be printed on the print 154 to aid the user in aligning the interlaced image of the print 154 with the lenses 188 of the lenticular sheet 182. A flip animated device 194 as shown in FIG. 14 results.

As shown in FIG. 15, the adhesive layer 184 may be in the form of a strip along one of the sides of the lenticular sheet 182. As shown in FIG. 16, a user may then mount the animated device 194 within a frame 195 for display and for holding the print 154 flat against the lenticular sheet 182. According to a preferred embodiment, the adhesive layer 184 may include pressure-sensitive adhesive so that the print 154 may be removed from the lenticular sheet 182 and repositioned thereon or, alternatively, replaced with another print if desired.

If the print 154 contains an anaglyph image, then the user may utilize stereo viewing glasses 196 as shown in FIG. 17 to view the image (step U68).

Referencing FIG. 1, if desired a user may add an overlay to the print 154 by utilizing an overlay button 198. An overlay may be an imported file for framing the image within the print 154. Alternatively, an overlay may be a logo printed on the print. In any case, the overlay is an image file that is not processed in creating the interlaced or anaglyph image.

In addition, the viewing distance may be adjusted by activating an adjust viewing distance button 200. The viewing distance is the distance a user views the animated or 3D device 194. If the viewing distance is not correct, the images may not have proper rolling animation or may ghost.

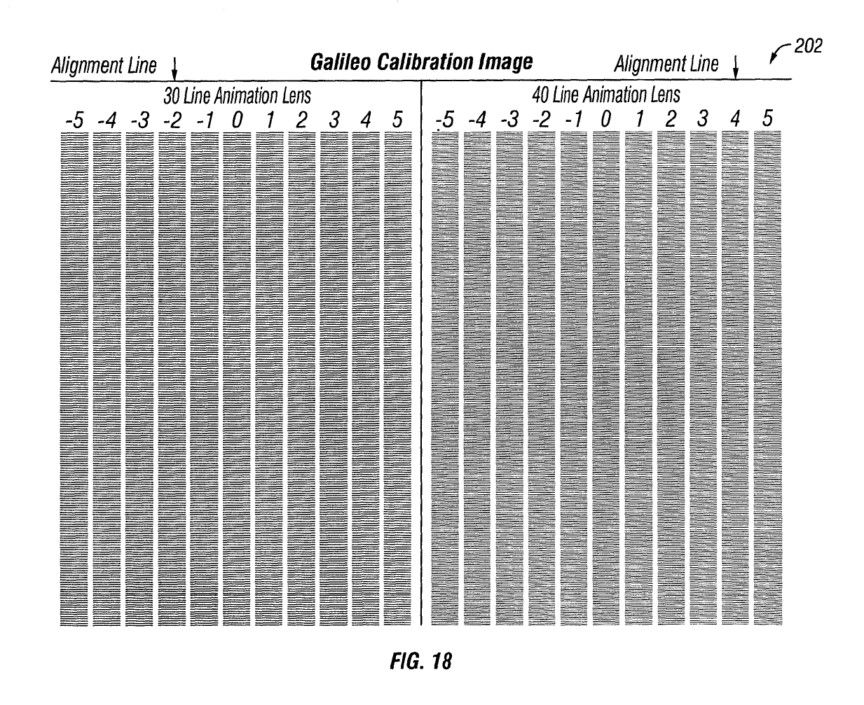

According to a preferred commercial embodiment of the invention, a kit including materials for producing animated and 3D devices may be provided. The kit may include one or more lenticular assemblies 180 (of varying resolution, e.g., 30 lpi and 40 lpi) and a pair of the stereo viewing glasses 196. In addition, the kit may include software code in the form of a plurality of computer readable instructions stored on a data storage medium, such as a CD-ROM 118 or a flopping disc 120. As mentioned above, the kit may include a web address so that the software code may be downloaded from a web site on the Internet. The kit may also include a calibration sheet 202 as shown in FIG. 18 that may be used to calibrate the lenticular sheets 182.

Those skilled in the art will understand that the preceding exemplary embodiments of the present invention provide the foundation for numerous alternatives and modifications thereto. These other modifications are also within the scope of the present invention such that the present invention is not limited to that precisely as shown and described in the present invention.

What is claimed is:

1. A method for creating a three-dimensional or an animated device, the method comprising:
causing a computer to import a plurality of images to a respective plurality of thumbnail windows;
causing the computer to generate a print of a processed image based on the plurality of images; and
mounting the print to a lenticular sheet.

2. A method as claimed in claim 1 wherein the lenticular sheet includes an adhesive layer, the mounting step comprising:
adhering the print to the adhesive layer.

3. A method as claimed in claim 2 wherein the lenticular sheet includes a backing sheet adhered to the adhesive layer, the mounting step further comprising:
removing the backing sheet from the adhesive layer.

4. A method as claimed in claim 2 wherein the adhesive layer includes pressure-sensitive adhesive, the method further comprising:
removing the print from the lenticular sheet.

5. A method as claimed in claim 4 further comprising:
causing the computer to generate a second print; and
adhering the second print to the adhesive layer.

6. A method as claimed in claim 1 wherein the step of causing the computer to generate a print further comprises:
causing the computer to print an alignment mark on the print.

7. A method as claimed in claim 6 wherein the lenticular sheet includes a plurality of lenses, the mounting step further comprises:
aligning the alignment mark with one of the lenses.

8. A method as claimed in claim 1 the step of causing a computer to import a plurality of images comprises:
causing the computer to import at least one image from a remote source.

9. A method as claimed in claim 1 further comprising:
causing the computer to modify the image imported to one of the thumbnail windows.

10. A method as claimed in claim 1 wherein the step of causing the computer to import a plurality of images further comprises:
causing the computer to import two images respectively to two thumbnail windows;
whereby a 2-flip animated device is produces when the print is mounted to the lenticular sheet.

11. A method as claimed in claim 1 wherein the step of causing the computer to import a plurality of images further comprises:
causing the computer to import three images respectively to three thumbnail windows;
whereby a 3-flip animated device is produces when the print is mounted to the lenticular sheet.

12. A method as claimed in claim 1 further comprising:
selecting one of a plurality of creation modes, thereby causing the computer to display a mode window corresponding to the selected creation mode, the mode window including the plurality of thumbnail windows.

13. A method as claimed in claim 12 wherein the plurality of creation modes includes a flip animation mode and a 3D mode.

14. A method for creating a three-dimensional anaglyph device, the method comprising:
causing a computer to import a plurality of images to a respective plurality of thumbnail windows;
causing the computer to generate a print of an anaglyph image based on the plurality of images; and
viewing the print with stereo viewing glasses.

15. A system for producing a three-dimensional or an animated device, the system comprising:
a printer;
a monitor;
a computer connected to the printer and the monitor, the computer for:
displaying a preview window and a plurality of thumbnail windows on the monitor;
importing a plurality of images to the plurality of thumbnail windows, respectively;
generating a processed image based on the plurality of images; and
causing the printer to generate a print of the processed image; and
a lenticular assembly including a lenticular sheet with an adhesive layer for receiving the print from the printer.

16. A system as claimed in claim 15 further comprising a digital camera connected to the computer, wherein the computer imports images from the digital camera.

17. A system as claimed in claim 15 wherein the computer is connected to and imports images from the Internet.

18. A system as claimed in claim 15 wherein the computer causes the printer to print an alignment mark on the print.

19. A system as claimed in claim 15 wherein the lenticular assembly further comprises a backing sheet removably adhered to the adhesive layer.

20. A kit for producing a three-dimensional or an animated device, the system comprising:
a printer;
a monitor;
a computer connected to the printer and the monitor, the computer for:
displaying a preview window and a plurality of thumbnail windows on the monitor;
importing a plurality of images to the plurality of thumbnail windows, respectively;
generating a processed image based on the plurality of images; and
causing the printer to generate a print of the processed image; and
a lenticular assembly including a lenticular sheet with an adhesive layer for receiving the print from the printer.

21. A system as claimed in claim 20 wherein the adhesive layer includes pressure-sensitive adhesive.

22. A system as claimed in claim 21 further comprising an article of manufacture including a computer-readable medium having stored thereon a plurality of instructions for enabling the computer to operate in accordance with the displaying, the importing, the generating and the causing steps.
